(19) United States
(12) Patent Application Publication
(10) Pub. No.: US 2025/0361350 A1
(43) Pub. Date: Nov. 27, 2025

(54) End-Modified Branched Block Copolymers As Dual-Functional Soil Surfactants and Humectants

(71) Applicant: Milliken & Company, Spartanburg, SC (US)

(72) Inventors: Nicholas G. Moon, Greer, SC (US); Shirley A. Whiteside, Chesnee, SC (US); Dominick J. Valenti, Moore, SC (US); Jimmy M. Stokes, Duncan, SC (US)

(21) Appl. No.: 19/294,475

(22) Filed: Aug. 8, 2025

Related U.S. Application Data
(62) Division of application No. 17/962,576, filed on Oct. 10, 2022.
(60) Provisional application No. 63/272,212, filed on Oct. 27, 2021.

(51) Int. Cl. C08F 293/00

(52) U.S. Cl. CPC C08F 293/00

(57) ABSTRACT

This invention relates to end-modified branched block copolymers for soil treatment applications. The end-modified branched block copolymers contain an alkoxylated block copolymer modified with a hydrophobic end group such as an alkysuccinic acid ester, a fatty acid ester, or an ether. Soils treated with these copolymers exhibit improved soil water penetration properties with enhanced atmospheric moisture absorption and provide overall healthier turf and/or plants contained therein.

### CROSS REFERENCE TO RELATED APPLICATIONS

This application claims priority to and is a division of U.S. patent application Ser. No. 17/962,576, entitled “End-Modified Branched Block Copolymers as Dual-Functional Soil Surfactants and Humectants,” which was filed on Oct. 10, 2022, which claims priority to U.S. Provisional Patent Application No. 63/272,212, entitled “End-Modified Branched Block Copolymers as Dual-Functional Soil Surfactants and Humectants,” which was filed on Oct. 27, 2021, both of which are entirely incorporated by reference herein.

### TECHNICAL FIELD

This invention relates to end-modified branched block copolymers for soil treatment applications. The end-modified branched block copolymers contain an alkoxylated block copolymer modified with a hydrophobic end group such as an alkysuccinic acid ester, a fatty acid ester, or an ether. Soils treated with these copolymers exhibit improved soil water penetration properties with enhanced atmospheric moisture absorption and provide overall healthier turf and/or plants contained therein.

### BACKGROUND

Golf courses and other managed turf environments are frequently built on sand-based soils. As organic material decays, the top layer of sand becomes hydrophobic. This results in uneven penetration of the water into the soil, with the water either pooling on the surface or channeling unevenly through the soil profile, leading to localized dry spot formation. In response, soil surfactants are often used to alter the hydrophobic character of the sand to allow water to penetrate evenly into the soil. This results in healthier, more aesthetically pleasing turf, and lower water usage requirements. Additionally, the usefulness of humectants in improving plant health under water-stressed conditions has been evaluated in some environments. Humectants absorb moisture from the atmosphere, making it more readily available to the plant roots. This leads to improved plant health under drought-stressed conditions or with reduced irrigation.

Typically, the types of molecules which perform well as soil surfactants are block copolymers of ethylene oxide (EO) and propylene oxide (PO). Products with high fractions of the more hydrophobic PO perform better as wetting agents. However, the high fraction of PO prevents the formation of large hydrophilic domains that are required for humectancy. As such, to achieve a product that provides humectant performance along with wetting performance, blending is required. Often, blends of the hydrophobic wetting agent and the hydrophilic humectant are not stable, and higher use rates are required to achieve comparable soil surfactant loadings. Additionally, the water-soluble nature of humectants can lead to poor longevity in the soil profile.

The present invention addresses these shortcomings and offers additional benefits over other types of soil surfactants and humectants. Therefore, the alkoxylated block copolymers of the present invention represent a useful advancement over the prior art and further fulfill a need that prevents dry spot formation and loss of turf and/or plants. It was found that multi-branched alkoxylated block copolymers having specific blends of EO and PO groups with hydrophobic end groups attached thereto provide these aforementioned benefits to soil.

### BRIEF SUMMARY

In one aspect, the invention relates to a branched, alkoxylated block copolymer modified with hydrophobic end groups having the following formula:

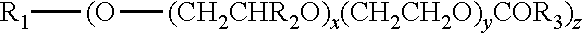

wherein:
R₁ is a multi-functional oxygen-containing polyol with at least 3 oxygen-containing reactive sites, preferably from 3 to 10 oxygen-containing reactive sites;
R₂ is H, CH₃, CH₂CH₃, phenyl, or CH₂ORₐ wherein Rₐ is any alkyl, aryl or siloxane group;
R₃ is either a hydrophobic end group which contains a carbon chain with 4 or more carbons or H, with at least one of the groups being the hydrophobic end group;
x is an integer from 1 to 200;
y is an integer from 1 to 250; and
z is an integer from 3 to 10.

In another aspect, the invention relates to a branched, alkoxylated block copolymer modified with hydrophobic end groups having the following formula:

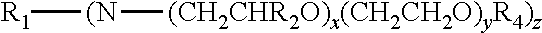

wherein:
R₁ is a multi-functional nitrogen-containing compound with at least 3 reactive sites;
R₂ is H, CH₃, CH₂CH₃, phenyl, or CH₂ORₐ wherein Rₐ is any alkyl, aryl or siloxane group;
R₄ is a either a hydrophobic end group which contains a carbon chain with 4 or more carbons or H, with at least one of the groups being the hydrophobic end group;
x is an integer from 1 to 200;
y is an integer from 1 to 250; and
z is an integer from 3 to 15.

In a further aspect, the invention relates to a branched, alkoxylated block copolymer modified with hydrophobic end groups having the following formula:

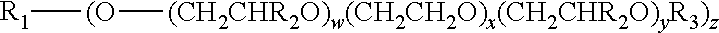

wherein:
R₁ is a multi-functional oxygen-containing polyol with at least 3 oxygen-containing reactive sites;
R₂ is H, CH₃, CH₂CH₃, phenyl, or CH₂ORₐ wherein Rₐ is any alkyl, aryl or siloxane group;
R₃ is either a hydrophobic end group which contains a carbon chain with 4 or more carbons or H, with at least one of the groups being the hydrophobic end group;
w is an integer from 1 to 200;
x is an integer from 1 to 250;
y is an integer from 1 to 200; and
z is an integer from 3 to 15.

In a further aspect, the invention relates to a branched, alkoxylated block copolymer modified with hydrophobic end groups having the following formula:

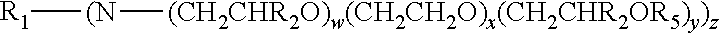

wherein:
R₁ is a multi-functional nitrogen-containing polyol with at least 3 reactive sites;
R₂ is H, CH₃, CH₂CH₃, phenyl, or CH₂ORₐ wherein Rₐ is any alkyl, aryl or siloxane group;
R₅ is either a hydrophobic end group which contains a carbon chain with 4 or more carbons or H, with at least one of the groups being the hydrophobic end group;
w is an integer from 1 to 200;
x is an integer from 1 to 250;
y is an integer from 1 to 200; and
z is an integer from 3 to 15.

### DETAILED DESCRIPTION

The present invention relates to a branched, alkoxylated block copolymer modified with hydrophobic end groups such as an alkylsuccinic ester, a fatty acid ester, or an ether. For the sake of this invention, hydrophobic groups are defined as those which contain a carbon chain of at least four carbons, preferably four to 20 carbon atoms. The carbon chain can be either branched or unbranched. This carbon can be either directly attached to the main chain as in the case of esters or ethers or branching from the main chain in the case of molecules modified by epoxides or alkylsuccinic anhydrides.

The alkoxylate composition is like the polymers described in U.S. Pat. No. 6,948,276 to Petrea et al. The alkoxylate component is selected from ethylene oxide (“EO”), propylene oxide (“PO”), butylene oxide (“BO”), and combinations thereof. However, a key difference is the balance between EO and PO. The polymer of the present invention has between 3 and 10 branches. Typical alkoxylates designed as surfactants for hydrophobic sand feature between 50% and 80% PO, with 70% and 80% being most preferred. The alkoxylates in this invention features between 10% and 50% PO, with 20% being most preferred. Additionally, blocks of random copolymers of EO and PO are disclosed herein.

In one aspect of the invention, the branched, alkoxylated block copolymer with hydrophobic end groups is as follows:

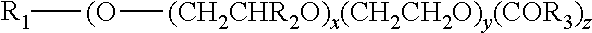

wherein:
R₁ is a multi-functional oxygen-containing polyol with at least 3 oxygen-containing reactive sites, preferably from 3 to 10 oxygen-containing reactive sites;
R₂ is H, CH₃, CH₂CH₃, phenyl, or CH₂ORₐ wherein Rₐ is any alkyl, aryl or siloxane group;
R₃ is either a hydrophobic end group which contains a carbon chain with 4 or more carbons, preferably 4 to 20 carbons, or H, with at least one of the groups being the hydrophobic end group;
x is an integer from 1 to 200, preferably from 20 to 80, more preferably from 30 to 50;
y is an integer from 1 to 250, preferably from 100 to 250, more preferably from 200 to 250;
z is an integer from 3 to 10, preferably from 4 to 8, more preferably from 6 to 7.

In a further aspect, the branched, alkoxylated block copolymer with hydrophobic end groups is as follows:

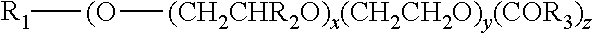

wherein:
R₁ is a multi-functional oxygen-containing polyol with at least 3 oxygen-containing reactive sites, preferably from 3 to 10 oxygen-containing reactive sites;
R₂ is H, CH₃, CH₂CH₃, phenyl, or CH₂ORₐ wherein Rₐ is any alkyl, aryl or siloxane group;
x is an integer from 30-120;
y is an integer from 100-250;
z is an integer from 3-7;
from 2 to 4 of the end groups are hydrophobic end groups; and
R₃ is an alkylsuccinic anhydride adduct.

Particular classes of polyols suitable for this purpose include, without limitation, tri-to octa-hydric alcohols such as pentaerythritol, diglycerol, α-methylglucoside, sorbitol, xylitol, mannitol, erythritol, dipentaerythritol, arabitol, glucose, sucrose, maltose, fructose, mannose, saccharose, galactose, leucrose, and other alditol or sugar molecules or polysaccharides; polybutadiene polyols; castor oil-derived polyols; hydroxyalkyl methacrylate copolymers; hydroxyalkyl acrylate polymers; polyvinyl alcohols; glycerine; 1,1,1-trimethylolpropane; 1,1,1-trimethylolethane; 1,2,6-hexanetriol; butanetriol; and mixtures thereof. Potentially preferred base compounds are the alditol types, particularly sorbitol and sucrose. The polyol can also be a blend of two or more of the above components.

Suitable polycarboxylic acids include, without limitation, tartaric acid; citric acid; ascorbic acid; 2-phosphono-1,2,4-butane tricarboxylic acid; glucuronic acid; ethylenediaminetetraacetic acid; gluconic acid; cyclohexane hexacarboxylic acid; mellitic acid; saccharic acid; mucic acid; diethylenetriamine pentaacetic acid; glucoheptonic acid; lactobionic acid; 3,3′,4,4′-benzophenone tetracarboxylic acid; amino propyl trimethoxysilane; aminopropyltriethoxysilane; 3-glycidoxypropyltrimethoxy silane; 3-glycidoxypropyltriethoxysilane; 3-(triethoxysilyl)propyl isocyanate; 3-(trimethoxysilyl)propyl isocyanate; diaminopropane-N,N,N′,N′-tetraacetic acid; aconitic acid; isocitric acid; 1,2,3,4-butanetetracarboxylic acid; nitrilotriacetic acid; tricarballylic acid; N-(phosphonomethyl)iminodiacetic acid; 3-[[tris(hydroxymethyl)methyl]amino]-1-propanesulfonic acid; 2-[[tris(hydroxymethyl)methyl]amino]-1-ethanesulfonic acid; 3-[bis(2-hydroxyethyl)amino]-2-hydroxy-1-propanesulfonic acid; 3-[N-trishydroxymethylmethylamino]-2-hydroxypropanesulfonic acid; N-tris[hydroxymethyl]methyl-4-aminobutanesulfonic acid; 3-aminoadipic acid; 1,3-diamino-2-hydroxypropane-N,N,N′,N′-tetraacetic acid; triethylenetetraaminehexaacetic acid; β-carboxyaspartic acid; α-hydroxymethylaspartic acid; tricine; 1,2,3,4-cyclopentanetetracar-carboxylic acid; 6-phosphogluconic acid; and mixtures thereof.

Suitable lactones include, without limitation, glucoheptonic lactone and glucooctanoic-.gamma.-lactone. Suitable amino acids include, without limitation, aspartic acid, α-glutamic acid, and β-glutamic acid.

The hydrophobic end group can be linked to the rest of the molecule by means of an ether or an ester. Selected compositions can include, but are not limited to, straight-chain ethers, branched ethers, fatty acid esters, and reaction products of alkylsuccinic anhydrides, aryl ethers, benzyl ethers, heteroaryl ethers, aryl esters, and heteroaryl esters.

In another aspect, the branched, alkoxylated block copolymer with modified end groups is as follows:

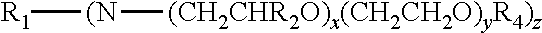

wherein:
R₁ is a multi-functional nitrogen-containing polyamine with at least 3 reactive sites, preferably from 3 to 10 reactive sites;
R₂ is H, CH₃, CH₂CH₃, phenyl, or CH₂ORₐ wherein Rₐ is any alkyl, aryl or siloxane group;
R₄ is either a hydrophobic end group which contains a carbon chain with 4 or more carbons or H, with at least one of the groups being an ether or ester;
x is an integer from 1 to 200, preferably from 20 to 80, more preferably from 30 to 50;
y is an integer from 1 to 250, preferably from 100 to 250, more preferably from 200 to 250; and
z is an integer from 3 to 15, preferably from 4 to 8, more preferably from 6 to 7.

A primary amine is counted as two reactive sites since it can add two moles of EO or PO. A secondary amine is counted as one reactive site. Some examples of suitable polyamines include, but are not limited to, ethylenediamine, diethylene triamine, triethylene tetramine, tetraethylene pentaamine, poly(ethylene imine), and poly(vinylamine).

The hydrophobic end group can be linked to the rest of the molecule by means of an ether or ester. Selected compositions can include, but are not limited to, straight-chain ethers, branched ethers, fatty acid esters, and reaction products of alkylsuccinic anhdydrides, aryl ethers, benzyl ethers, heteroaryl ethers, aryl esters, and heteroaryl esters.

In yet a further aspect of the invention, the branched, alkoxylated block copolymer with modified end groups is as follows:

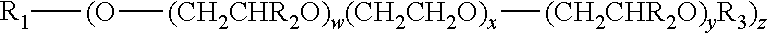

wherein:
R₁ is a multi-functional oxygen-containing polyol with at least 3 oxygen-containing reactive sites, preferably from 3 to 10 oxygen-containing reactive sites;
R₂ is H, CH₃, CH₂CH₃, phenyl, or CH₂ORₐ wherein Rₐ is any alkyl, aryl or siloxane group;
R₃ is either a hydrophobic end group which contains a carbon chain with 4 or more carbons or H, with at least one of the groups being the hydrophobic end group;
w is an integer from 1 to 200, preferably from 20 to 80, more preferably from 30 to 50;
x is an integer from 1 to 250, preferably from 100 to 250, more preferably from 200 to 250; and
y is an integer from 1 to 200, preferably from 20 to 80, more preferably from 30 to 50;
z is an integer from 3 to 15, preferably from 4 to 8, more preferably from 6 to 7.

In another aspect of the invention, the branched, alkoxylated block copolymer with modified end groups is as follows:

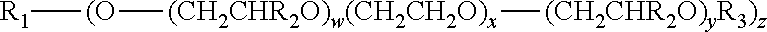

wherein:
R₁ is a multi-functional oxygen-containing polyol with at least 3 oxygen-containing reactive sites, preferably from 3 to 10 oxygen-containing reactive sites;
R₂ is H, CH₃, CH₂CH₃, phenyl, or CH₂ORₐ wherein Rₐ is any alkyl, aryl or siloxane group;
w is an integer from 15-60;
x is an integer from 100-250;
y is an integer from 15-60;
z is an integer from 3-7;
from 2 to 4 of the end groups are hydrophobic end groups, and
R₃ is an alkylsuccinic anhydride adduct.

Polyols are as described previously herein. Esters made from the reaction between the polymer and an alkylsuccinic anhydride such as octenylsuccinic anhydride are most preferred.

In another aspect, the branched, alkoxylated block copolymer with modified end groups is as follows:

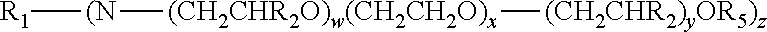

wherein:
R₁ is a multi-functional nitrogen-containing polyol with at least 3 reactive sites, preferably from 3 to 10 reactive sites;
R₂ is H, CH₃, CH₂CH₃, phenyl, or CH₂ORₐ wherein Rₐ is any alkyl, aryl or siloxane group;
R₅ is either a hydrophobic end group which contains a carbon chain with 4 or more carbons or H, with at least one of the groups being the hydrophobic end group;
w is an integer from 1 to 200, preferably from 20 to 80, more preferably from 30 to 50;
x is an integer from 1 to 250, preferably from 100 to 250, more preferably from 200 to 250; and
y is an integer from 1 to 200, preferably from 20 to 80, more preferably from 30 to 50;
z is an integer from 3 to 15, preferably from 4 to 8, more preferably from 6 to 7.

Reactive sites, polyamine and esters are as described previously herein.

As stated herein, x and y can vary between 1 and 250. The ratio of x and y are set such that the polymer contains no more than 50 wt % PO as defined by the equation:

$$\% PO = \frac{x \cdot 58}{( x \cdot 58 ) + ( y \cdot 44 )} \times 100 .$$

The branched alkoxylate is functionalized with at least one hydrophobic end group which contains alkyl chains having 4 or more carbon atoms. More preferred is 3 to 6 functional groups per molecule. Most preferred is 2 to 4.

Unique to these molecules is the ability to improve water infiltration into hydrophobic soil while also absorbing moisture from the air. The molecules absorb at least 10% moisture from the air in neat form at room temperature and 85% relative humidity.

These molecules may additionally be blended with one or more components such as another compound that actively lowers the surface tension of water such as a phenol ethoxylate, an alcohol ethoxylate, an alkyl sulfate, and alkyl phosphate, a linear ethylene oxide/propylene oxide block copolymer such as L62, polyols, poly(ethylene glycol), propylene carbonate, glycerin carbonate, or water; another unfunctionalized branched block copolymers like those discussed in U.S. Pat. No. 6,948,276, an alkylpolyglycoside, or any other compound known in the art to function as a surfactant; an inactive diluent such as propylene glycol, dipropylene glycol, alkoxylated; a fertilizer; a pesticide; a biostimulant; and a colorant.

It has been unexpectedly discovered that incorporating long-chain alkyl groups provides a stronger effect in lowering the surface tension and increasing water infiltration compared to PO. Typically, wetting agents such as those described in U.S. Pat. No. 6,948,276 and Pluronic L62 available from BASF rely on large PO domains to achieve the desired water infiltration behavior. However, humectancy requires hydrophilic molecules to effectively condense water from the atmosphere. The hydrophobic end group enables the wetting agent to function efficiently without sacrificing the high wt % EO that is required for moisture absorption. By tailoring the EO/PO ratio and the amount of hydrophobic group, a wetter with a balance of properties can be achieved. The improved performance can be seen by the examples presented herein.

### EXAMPLES

The following Examples are provided for illustration purposes and should not be considered as limiting the scope of the invention. These examples are intended to demonstrate the dual-functional soil surfactant and humectant properties of the end-modified branched block copolymers of the current invention.

### General Method 1: Determination of Moisture Regain

An empty aluminum pan was tared and 1-2 grams of sample was placed in the pan. The pan was reweighed to determine the exact mass of the sample. The pans were placed in a chamber at room temperature with a controlled humidity of approximately 85% using a saturated KCl solution. The samples were kept in these conditions for 1 week and reweighted. The % moisture regain was determined by dividing the final mass by the original mass and subtracting 100% according to the following equation.

$$\% Regain = \frac{{m}_{final}}{{m}_{initial}} - 100 \%$$

### General Method 2: Straw Infiltration Test

A blend of 92% GA-4 golf-course grade sand and 8% dried, sifted organic peat moss available from any garden store were combined and agitated thoroughly to mix. Then, three clear drinking straws with a bendable end were stoppered with cotton at the end (not the flexible end) and filled with 2 g of the sand/peat mixture. The straw was positioned flat on a surface with the bent part pointing up at an approximately 45° angle. A 2.3% solution (2 g) of the wetter in water was added at one time and the time it took for the water to reach the end of the sand as evidenced by the appearance of liquid in the cotton was recorded. The final number was recorded as the average of three runs.

### Example 1: Octenylsuccinic Anhydride (OSA)-functionalized Sorbitol 12000 50:50 PO:EO

The six-arm branched alkoxylate Sorbitol 12000 50:50 PO:EO was synthesized according to the following method. Propoxylated sorbitol (MW=4532) was added into a steel autoclave (375 g) followed by KOH flake (5.2 g). The autoclave was sealed and heated to 230° F. and stripped under vacuum until the % water was less than 0.05%. At this point, the reactor was heated to 280° F. and 134 g of propylene oxide (PO) was added followed by 493 g ethylene oxide (EO). When the reaction was complete, the mixture was vacuum stripped to remove residual oxide and removed from the reactor.

A round-bottomed flask was equipped with a nitrogen inlet, mechanical stirrer, and temperature probe. To the flask was charged Sorbitol 12000 50/50 block (100 g) and sufficient OSA to equal between 1 and 6 mol OSA per polymer chain. Table 1 shows the OSA charge relative to the number of moles of OSA per molecule. The mixture was heated to 100° C. for 1 hour. When the anhydride was consumed, the product was cooled to room temperature and transferred to a container. Table 2 shows the infiltration time and moisture regain for the samples made in Example 1.

TABLE 1
OSA charges for Example 1

| | # mol | OSA |
|---|---|---|
| Example | OSA | Charge (g) |
| 1A | 1 | 1.8 |
| 1B | 2 | 3.6 |
| 1C | 3 | 5.4 |
| 1D | 4 | 7.2 |
| 1E | 5 | 9.0 |
| 1F | 6 | 10.8 |

TABLE 2
Infiltration time and moisture regain for Example 1

| | Sample | Infiltration | Moisture |
|---|---|---|---|
| Sample | Description | Time (sec) | Regain (%) |
| Control | Sorbitol 12000 | 303 | 23.5 |
| (unfunctionalized) | 50:50 PO:EO | | |
| 1A | Sorbitol 12000 | 305 | 22.7 |
| | 50:50 PO:EO 1OSA | | |
| 1B | Sorbitol 12000 | 273 | 20.1 |
| | 50:50 PO:EO 2OSA | | |
| 1C | Sorbitol 12000 | 206 | 18.1 |
| | 50:50 PO:EO 3OSA | | |
| 1D | Sorbitol 12000 | 249 | 16.5 |
| | 50:50 PO:EO 4OSA | | |
| 1E | Sorbitol 12000 | 281 | 15.2 |
| | 50:50 PO:EO 5OSA | | |
| 1F | Sorbitol 12000 | 287 | 13.7 |
| | 50:50 PO:EO 6OSA | | |

### Example 2: OSA-functionalized Sorbitol 12000 20:80 PO:EO

The six-arm branched alkoxylate Sorbitol 12000 20:80 PO:EO was synthesized according to the following method. Propoxylated sorbitol (MW=1342) was added into a steel autoclave (690 g) followed by KOH flake (12.0 g). The autoclave was sealed and heated to 230° F. and stripped under vacuum until the % water was less than 0.05%. At this point, the reactor was heated to 280° F. and 596 g of propylene oxide (PO) was added followed by 4697 g ethylene oxide (EO). When the reaction was complete, the mixture was vacuum stripped to remove residual oxide and removed from the reactor.

A round-bottomed flask was equipped with a nitrogen inlet, mechanical stirrer, and temperature probe. To the flask was charged Sorbitol 12000 20/80 block (100 g) and sufficient OSA to equal between 1 and 6 mol OSA per polymer chain. Table 3 shows the appropriate charges. The mixture was heated to 100° C. for 1 hour. When the anhydride was consumed, the product was cooled to room temperature and transferred to a container. Table 4 compares the infiltration time and moisture regain for Example 2.

TABLE 3
OSA Charges for Example 2

| | # mol | OSA |
|---|---|---|
| Example | OSA | Charge (g) |
| 2A | 1 | 1.7 |
| 2B | 2 | 3.4 |
| 2C | 3 | 5.1 |
| 2D | 4 | 6.8 |
| 2E | 5 | 8.5 |
| 2F | 6 | 10.2 |

TABLE 4
Infiltration time and moisture regain for Example 2

| | Sample | Infiltration | Moisture |
|---|---|---|---|
| Sample | Description | Time (sec) | Regain (%) |
| Control | Sorbitol 12000 | 369 | 8.4 |
| (unfunctionalized) | 20:80 PO:EO | | |
| 2A | Sorbitol 12000 | 377 | 7.9 |
| | 20:80 1OSA | | |
| 2B | Sorbitol 12000 | 315 | 12.9 |
| | 20:80 PO:EO 2OSA | | |
| 2C | Sorbitol 12000 | 426 | 27.6 |
| | 20:80 PO:EO 3OSA | | |
| 2D | Sorbitol 12000 | 323 | 27.9 |
| | 20:80 PO:EO 4OSA | | |
| 2E | Sorbitol 12000 | 280 | 26.6 |
| | 20:80 PO:EO 5OSA | | |
| 2F | Sorbitol 12000 | 423 | 24.3 |
| | 20:80 PO:EO 6OSA | | |

### Example 3: OSA-functionalized Sorbitol 12000 25:50:25 PO:EO:PO

The six-arm branched alkoxylate Sorbitol 12000 25:50:25 PO:EO:PO was synthesized according to the following method. Propoxylated sorbitol (MW=1342) was added into a steel autoclave (300 g) followed by KOH flake (5.4 g). The autoclave was sealed and heated to 230° F. and stripped under vacuum until the % water was less than 0.05%. At this point, the reactor was heated to 280° F. and 388 g of propylene oxide (PO) was added followed by 1333 g ethylene oxide (EO) and then an additional 672 g propylene oxide (PO). When the reaction was complete, the mixture was vacuum stripped to remove residual oxide and removed from the reactor.

A round-bottomed flask was equipped with a nitrogen inlet, mechanical stirrer, and temperature probe. To the flask was charged Sorbitol 12000 25:50:25 PO:EO:PO block (100 g) and sufficient OSA to equal between 1 and 6 mol OSA per polymer chain. Table 5 shows the OSA charges for Example 3. The mixture was heated to 100° C. for 1 hour. When the anhydride was consumed, the product was cooled to room temperature and transferred to a container. Table 6 compares the infiltration time and moisture regain for Example 3.

TABLE 5
OSA charges for Example 3

| | # mol | OSA |
|---|---|---|
| Example | OSA | Charge (g) |
| 3A | 1 | 1.9 |
| 3B | 2 | 3.9 |
| 3C | 3 | 5.8 |
| 3D | 4 | 7.7 |
| 3E | 5 | 9.7 |
| 3F | 6 | 11.6 |

TABLE 6
Infiltration time and moisture regain for Example 3

| | Sample | Infiltration | Moisture |
|---|---|---|---|
| Sample | Description | Time (sec) | Regain (%) |
| Control | Sorbitol 12000 | 403 | 17.6 |
| (unfunctionalized) | 25:50:25 PO:EO:PO | | |
| 3A | Sorbitol 12000 | 401 | 16.1 |
| | 25:50:25 PO:EO:PO | | |
| | 1OSA | | |
| 3B | Sorbitol 12000 | 247 | 14.4 |
| | 25:50:25 PO:EO:PO | | |
| | 2OSA | | |
| 3C | Sorbitol 12000 | 262 | 12.8 |
| | 25:50:25 PO:EO:PO | | |
| | 3OSA | | |
| 3D | Sorbitol 12000 | 250 | 12.1 |
| | 25:50:25 PO:EO:PO | | |
| | 4OSA | | |
| 3E | Sorbitol 12000 | 384 | 11.2 |
| | 25:50:25 PO:EO:PO | | |
| | 5OSA | | |
| 3F | Sorbitol 12000 | 1163 | 10.5 |
| | 25:50:25 PO:EO:PO | | |
| | 6OSA | | |

### Example 4: OSA-functionalized Sorbitol 12000 10:80:10 PO:EO:PO

The six-arm branched alkoxylate Sorbitol 12000 10:80:10 was synthesized according to the following method. Propoxylated sorbitol (MW=1342) was added into a steel autoclave (300 g) followed by KOH flake (5.2 g). The autoclave was sealed and heated to 230° F. and stripped under vacuum until the % water was less than 0.05%. At this point, the reactor was heated to 280° F. and 2070 g ethylene oxide (EO) was added. When the reaction was complete, the mixture was vacuum stripped to remove residual oxide and removed from the reactor.

A round-bottomed flask was equipped with a nitrogen inlet, mechanical stirrer, and temperature probe. To the flask was charged Sorbitol 12000 10:80:10 block (100 g) and sufficient OSA to equal between 1 and 6 mol OSA per polymer chain. Table 7 shows the OSA charges for Example 4. The mixture was heated to 100° C. for 1 hour. When the anhydride was consumed, the product was cooled to room temperature and transferred to a container. Table 8 shows the infiltration time and moisture regain for Example 4.

TABLE 7
OSA charges for Example 4

| | # mol | OSA |
|---|---|---|
| Example | OSA | Charge (g) |
| 4A | 1 | 1.8 |
| 4B | 2 | 3.6 |
| 4C | 3 | 5.4 |
| 4D | 4 | 7.2 |
| 4E | 5 | 9.0 |
| 4F | 6 | 10.8 |

TABLE 8
Infiltration time and moisture regain for Example 4

| | Sample | Infiltration | Moisture |
|---|---|---|---|
| Sample | Description | Time (sec) | Regain (%) |
| Control | Sorbitol 12000 | 323 | 34.6 |
| (unfunctionalized) | 10:80:10 PO:EO:PO | | |
| 4A | Sorbitol 12000 | 249 | 31.7 |
| | 10:80:10 PO:EO:PO | | |
| | 1OSA | | |
| 4B | Sorbitol 12000 | 218 | 29.0 |
| | 10:80:10 PO:EO:PO | | |
| | 2OSA | | |
| 4C | Sorbitol 12000 | 306 | 26.9 |
| | 10:80:10 PO:EO:PO | | |
| | 3OSA | | |
| 4D | Sorbitol 12000 | 328 | 26.2 |
| | 10:80:10 PO:EO:PO | | |
| | 4OSA | | |
| 4E | Sorbitol 12000 | 344 | 23.1 |
| | 10:80:10 PO:EO:PO | | |
| | 5OSA | | |
| 4F | Sorbitol 12000 | 396 | 21.7 |
| | 10:80:10 PO:EO:PO | | |
| | 6OSA | | |

### Example 5: Dodecenylsuccinic anhydride (DDSA)-functionalized Sorbitol 12000 50:50 PO:EO

The six-arm branched alkoxylate Sorbitol 12000 50:50 PO:EO was synthesized as described above.

A round-bottomed flask was equipped with a nitrogen inlet, mechanical stirrer, and temperature probe. To the flask was charged Sorbitol 12000 50:50 PO:EO block (100 g) and 4.6 g dodecenyl succinic anhydride (“DDSA”). The mixture was heated to 100° C. for 1 hour. When the anhydride was consumed, the product was cooled to room temperature and transferred to a container. Table 9 compares the infiltration time of the unmodified block copolymer with the functionalized example.

TABLE 9
Infiltration time and moisture regain for Example 5

| | Sample | Infiltration | Moisture |
|---|---|---|---|
| Sample | Description | Time (sec) | Regain (%) |
| Control | Sorbitol 12000 | 303 | 23.47 |
| (unfunctionalized) | 50:50 | | |
| 5 | Sorbitol 12000 | 217 | 17.5 |
| | 50:50 2DDSA | | |

### Example 6: DDSA-functionalized Sorbitol 12000 20:80 PO:EO

The six-arm branched alkoxylate Sorbitol 12000 20:80 PO:EO was synthesized as described above.

A round-bottomed flask was equipped with a nitrogen inlet, mechanical stirrer, and temperature probe. To the flask was charged Sorbitol 12000 10:80:10 block (100 g) and sufficient DDSA to equal between 3 and 4 mol DDSA per polymer chain. Table 10 shows the DDSA charges. The mixture was heated to 100° C. for 1 hour. When the anhydride was consumed, the product was cooled to room temperature and transferred to a container. Table 11 showed the infiltration time and moisture regain for Example 6.

TABLE 10
DDSA charges for Example 6

| | # mol | DDSA |
|---|---|---|
| Sample | DDSA | Charge (g) |
| 6A | 3 | 6.4 |
| 6B | 4 | 8.5 |

TABLE 11
Infiltration time and moisture regain for Example 6

| | Sample | Infiltration | Moisture |
|---|---|---|---|
| Sample | Description | Time (sec) | Regain (%) |
| Control | Sorbitol 12000 | 369 | 8.41 |
| (unfunctionalized) | 10:80:10PO:EO | | |
| 6A | Sorbitol 12000 | 302 | 12.95 |
| | 20:80PO:EO 3DDSA | | |
| 6B | Sorbitol 12000 | 387 | 22.05 |
| | 10:80:10 PO:EO | | |
| | 4DDSA | | |

All the above examples show a clear decrease in the infiltration time relative to the unfunctionalized block copolymer while maintaining a high moisture regain. Tuning the block copolymer composition and degree of functionalization enables the two competing properties to be effectively balanced to give a dual-functional molecule.

### Comparative Example 1: Comparison with Commercial Controls

Several comparative samples were subjected to General Method 1 and General Method 2. Test results are provided in Table 12.

TABLE 2
Infiltration time and moisture regain for Comparative Examples

| | Infiltration | Moisture |
|---|---|---|
| Sample | Time (sec) | Regain (%) |
| L62 | 235 | 10.38 |
| 25R2 | 160 | 4.58 |
| Revolution ® soil | 228 | 5.44 |
| surfactant | | |

The data shows that adding intermediate quantities of an alkylsuccinic anyhydride decreases the infiltration time relative to the unmodified samples without significantly affecting the moisture absorption. The moisture absorption is often several times higher than comparative soil surfactants Pluronic L62 and 25R₂ which are available from BASF, and Revolution from Aquatrols while maintaining comparable infiltration times.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

We claim:

1. A branched, alkoxylated block copolymer modified with hydrophobic end groups having the following formula: 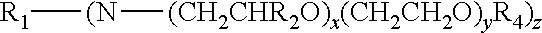
wherein:
R₁ is a multi-functional nitrogen-containing compound with at least 3 reactive sites;
R₂ is H, CH₃, CH₂CH₃, phenyl, or CH₂ORₐ wherein Rₐ is any alkyl, aryl or siloxane group;
R₄ is a either a hydrophobic end group which contains a carbon chain with 4 or more carbons or H, with at least one of the groups being the hydrophobic end group;
x is an integer from 1 to 200;
y is an integer from 1 to 250; and
z is an integer from 3 to 15.

2. The branched, alkoxylated block copolymer of claim 1, wherein R₁ contains between 3 and 10 reactive sites.

3. The branched, alkoxylated block copolymer of claim 1, wherein x is an integer from 20 to 80.

4. The branched, alkoxylated block copolymer of claim 1, wherein y is an integer from 100 to 250.

5. A branched, alkoxylated block copolymer modified with hydrophobic end groups having the following formula: 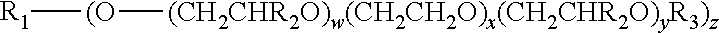
wherein:
R₁ is a multi-functional oxygen-containing polyol with at least 3 oxygen-containing reactive sites;
R₂ is H, CH₃, CH₂CH₃, phenyl, or CH₂ORₐ wherein Rₐ is any alkyl, aryl or siloxane group;
R₃ is either a hydrophobic end group which contains a carbon chain with 4 or more carbons or H, with at least one of the groups being the hydrophobic end group;
w is an integer from 1 to 200;
x is an integer from 1 to 250;
y is an integer from 1 to 200; and
z is an integer from 3 to 15.

6. The branched, alkoxylated block copolymer of claim 5, wherein R₁ contains between 3 and 10 reactive sites.

7. The branched, alkoxylated block copolymer of claim 5, wherein w is an integer from 20 to 80.

8. The branched, alkoxylated block copolymer of claim 5, wherein x is an integer from 100 to 250.

9. The branched, alkoxylated block copolymer of claim 5, wherein:
w is an integer from 15-60,
x is an integer from 100-250,
y is an integer from 15-60,
z is an integer from 3-7,
from 2 to 4 of the end groups are hydrophobic end groups, and
R₃ is an alkylsuccinic anhydride adduct.

10. A branched, alkoxylated block copolymer modified with hydrophobic end groups having the following formula: 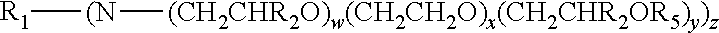
wherein:
R₁ is a multi-functional nitrogen-containing polyol with at least 3 reactive sites;
R₂ is H, CH₃, CH₂CH₃, phenyl, or CH₂ORₐ wherein Rₐ is any alkyl, aryl or siloxane group;
R₅ is either a hydrophobic end group which contains a carbon chain with 4 or more carbons or H, with at least one of the groups being the hydrophobic end group;
w is an integer from 1 to 200;
x is an integer from 1 to 250;
y is an integer from 1 to 200; and
z is an integer from 3 to 15.

11. The branched, alkoxylated block copolymer of claim 10, wherein R₁ contains between 3 and 10 reactive sites.

12. The branched, alkoxylated block copolymer of claim 10, wherein w is an integer from 20 to 80.

13. The branched, alkoxylated block copolymer of claim 10, wherein x is an integer from 100 to 250.
